(19) United States
(12) Patent Application Publication
(10) Pub. No.: US 2012/0076539 A1
(43) Pub. Date: Mar. 29, 2012

(54) CHARGING MEMBER

(75) Inventors: Taichi Sato, Numazu-shi (JP); Masaaki Harada, Yokohama-shi (JP); Yukinori Nagata, Mishima-shi (JP); Toshiro Suzuki, Gotemba-shi (JP)

(73) Assignee: CANON KABUSHIKI KAISHA, Tokyo (JP)

(21) Appl. No.: 13/308,485

(22) Filed: Nov. 30, 2011

Related U.S. Application Data
(63) Continuation of application No. PCT/JP2011/004171, filed on Jul. 25, 2011.

(30) Foreign Application Priority Data
Aug. 20, 2010 (JP) 2010-185122

(51) Int. Cl. G03G 15/02; B32B 3/10

(52) U.S. Cl. 399/174; 428/149; 428/148

(57) ABSTRACT

A charging member is provided which can not easily change in charging performance even because of its service over a long period of time. The charging member has a conductive support, an elastic layer and a surface layer. The elastic layer comprises spherical particles in such a way that the spherical particles are exposed at least in part to the surface of the elastic layer so as to make the surface of the elastic layer roughened; the spherical particles are at least one type selected from the group consisting of spherical silica particles, spherical alumina particles and spherical zirconia particles; the surface of the elastic layer is overlaid with the surface layer in such a way that the surface profile of the elastic layer is reflected on the surface profile of the charging member; and the surface layer comprises a high-molecular compound having a specific constituent unit.

This application is a continuation of International Application No. PCT/JP2011/004171, filed Jul. 25, 2011, which claims the benefit of Japanese Patent Application No. 2010-185122, filed Aug. 20, 2010.

### BACKGROUND OF THE INVENTION

1. Field of the Invention

This invention relates to a charging member.

2. Description of the Related Art

In electrophotographic apparatus, a contact charging system is known in which a voltage is applied to a charging member disposed in contact with the surface of a drum-shaped photosensitive member to cause micro-discharge to take place in the vicinity of a nip between them to charge the surface of the photosensitive member electrostatically.

As the charging member used in such a contact charging system, as disclosed in PTL 1, it is common to make its surface roughened by incorporating particles in a surface layer in order to make, e.g., a developer less adhere to the surface and also make the discharge stable.

Meanwhile, PTL 2 discloses a charging member an electrically conductive elastic layer of which is provided thereon with a thin surface layer having a high electrical resistance, containing a polysiloxane having an oxyalkylene group, to thereby improve its charging ability.

### CITATION LIST

PTL 1: Japanese Patent Application Laid-open No. 2005-345801
PTL 2: Japanese Patent Application Laid-open No. 2009-086263

### SUMMARY OF THE INVENTION

In the charging member the surface layer of which is incorporated with fine particles to thereby make the surface roughened as disclosed in the above PTL 1, the surface layer comes to wear gradually because of its repeated contact with the photosensitive member. As it does, the fine particles come off the surface layer continually until the surface layer of the charging member changes in its profile in some cases. As the result, the charging member may change with time in its charging performance.

Accordingly, the present invention is directed to providing a charging member that can not easily change in charging performance even because of its service over a long period of time.

Further the present invention is directed to providing an electrophotographic apparatus that can stably form high-grade electrophotographic images.

According to one aspect of the present invention, there is provided a charging member comprising a conductive support, an elastic layer and a surface layer, wherein; the elastic layer comprises spherical particles in such a way that the spherical particles are exposed at least in part to the surface of the elastic layer, and the surface of the elastic layer is roughened thereby;

wherein,

the spherical particles are at least one selected from the group consisting of spherical silica particles, spherical alumina particles and spherical zirconia particles; the surface of the elastic layer is overlaid with the surface layer in such a way that the surface profile of the elastic layer is reflected on the surface profile of the charging member; and the surface layer comprises a high-molecular compound having a constituent unit represented by the following formula (1).

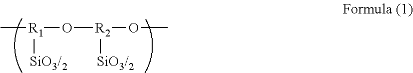

In the formula (1), R₁ and R₂ each independently represent any of structures represented by the following formulas (2) to (5).

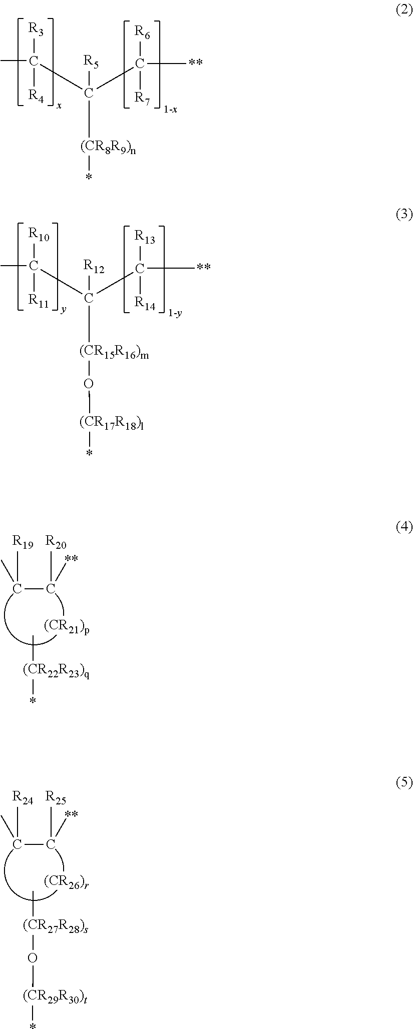

In the formulas (2) to (5), R₃ to R₇, R₁₀ to R₁₄, R₁₉, R₂₀, R₂₄ and R₂₅ each independently represent a hydrogen atom, an alkyl group having 1 to 4 carbon atom(s), a hydroxyl group, a carboxyl group or an amino group; R₈, R₉, R₁₅ to R₁₈, R₂₂, R₂₃ and R₂₇ to R₃₀ each independently represent a hydrogen atom or an alkyl group having 1 to 4 carbon atom(s); n, m, l, q, s and t each independently represent an integer of 1 to 8, p and r each independently represent an integer of 4 to 12, and x and y each independently represent 0 or 1; and an asterisk * represents the position of bonding with the silicon atom in the formula (1), and a double asterisk ** represents the position of bonding with the oxygen atom in the formula (1).

According to another aspect of the present invention, there is provided an electrophotographic apparatus comprising an electrophotographic photosensitive member and a charging member disposed in contact with the electrophotographic photosensitive member, wherein the charging member is the above charging member.

According to the present invention, a charging member can be obtained which can not easily change in charging performance. According to the present invention, an electrophotographic apparatus can also be obtained which can stably form high-grade electrophotographic images.

Further features of the present invention will become apparent from the following description of exemplary embodiments with reference to the attached drawings.

### BRIEF DESCRIPTION OF THE DRAWINGS

FIG. 1 is a diagrammatic view showing the surface state of the charging member of the present invention.

FIG. 2 is a sectional view showing an example of the charging member of the present invention.

FIG. 3 is a schematic view showing an example of the construction of an electrophotographic apparatus to which the charging member of the present invention is applied.

### DESCRIPTION OF THE EMBODIMENTS

The charging member of the present invention has a conductive substrate, an elastic layer and a surface layer.

<Conductive Substrate>

The substrate is one having the strength to enable support of the charging member and surface layer to be provided thereon and having electrical conductivity. As materials for the substrate, usable are, e.g., metals such as iron, copper, stainless steel, aluminum and nickel, and alloys of any of these. The substrate may also be subjected on its surface to surface treatment such as plating for the purpose of providing scratch resistance, as long as the electrical conductivity is not damaged.

<Elastic Layer>

The elastic layer is one providing the charging member with the elasticity to enable formation of a nip between it and the photosensitive member, and the electrical conductivity, and may be formed with use of a base polymer and additives. The base polymer may be any material as long as it has rubber elasticity in the range of service temperature of the charging member.

The base polymer may include as specific examples thereof the following: Natural rubber (NR), isoprene rubber (IR), butadiene rubber (BR), styrene-butadiene rubber (SBR), butyl rubber (IIR), an ethylene-propylene-diene terpolymer rubber (EPDM), an epichlorohydrin homopolymer (CHC), an epichlorohydrin-ethylene oxide copolymer (CHR), an epichlorohydrin-ethylene oxide-acrylic glycidyl ether terpolymer (CHR-AGE), an acrylonitrile-butadiene copolymer (NBR), a hydrogenated product of acrylonitrile-butadiene copolymer (H-NBR), chloroprene rubber (CR) and acrylic rubbers (ACM, ANM).

Also usable as the base polymer are any of heat-curable rubber materials obtained by compounding the base polymer with a cross-linking agent and thermoplastic elastomers such as polyolefin type, polystyrene type, polyester type, polyurethane type, polyamide type and vinyl chloride type ones.

The elastic layer according to the present invention comprises at least one type of spherical particles selected from the group consisting of spherical silica particles, spherical alumina particles and spherical zirconia particles, in such a way that the spherical particles are exposed at least in part to the surface of the elastic layer. The spherical particles exposed at least in part to the surface make the surface of the elastic layer roughened.

The spherical silica particles, spherical alumina particles and spherical zirconia particles all have a high hardness, and hence the spherical particles themselves are difficult to be abraded even in a grinding step in the process of forming the elastic layer as described later. Hence, the particles can be made exposed in part to the surface of the elastic layer while being kept spherical.

In the charging member according to the present invention, the surface of the elastic layer standing roughened is also overlaid with the surface layer, detailed later, in such a way that the surface profile of the elastic layer is reflected on the surface profile of the charging member. This feature and the rigidity of the surface layer itself combine to make the charging member well maintain its surface profile also when the charging member is pressed against the photosensitive member at the nip between them.

The spherical silica particles, spherical alumina particles and spherical zirconia particles in the present invention are spherical particles composed of silica, alumina and zirconia, respectively, as chief components, and may also contain the other substance(s). These spherical particles may have a hardness of 7 or more in amended Mohs hardness. As long as their amended Mohs hardness is 7 or more, the spherical particles can be kept from deforming at the nip the charging member forms between it and the photosensitive member, and the area of its contact with the photosensitive member can be kept from increasing.

These spherical particles may preferably have an average particle diameter of approximately from 2 μm or more to 80 μm or less, and particularly from 5 μm or more to 40 μm or less. Setting it within this range enables the charging member to be kept from increasing in contact surface at the nip when the charging member is pressed against the photosensitive member. This also facilitates control of the surface profile of the charging member to make it have the surface profile that enables any toner and so forth to be effectively kept from adhering to the surface of the charging member.

Here, the average particle diameter of the spherical particles may employ the length-average particle diameter that is determined by the following method. Photographic images of spherical particles photographed on a scanning electron microscope (JEOL LV5910, manufactured by JEOL Ltd.) are analyzed by using image analysis software (trade name: IMAGE-PRO PLUS; available from Planetron Co.). To make analysis, the number of pixels per unit length is calibrated from micron bars at the time of photography, where, in respect of 50 particles picked up at random from the photograph, their unidirectional particle diameters are measured from the number of pixels on the image to determine the arithmetic mean of measured values found, which is taken as the length-average particle diameter.

As the sphericity of the spherical particles, the spherical particles may also preferably be from 100 or more to 160 or less as the value of shape factor SF1. The shape factor SF1 is an index represented by equation (1) shown below, and means that, the closer to 100 it is, the closer to spheres the particles are. The shape factor SF1 of the spherical particles may employ the value measured by the following method. The information of images photographed on the scanning electron microscope is inputted into an image analyzer (LUZEX 3, manufactured by Nireco Corporation), where, in respect of 50 particles picked up at random, their shape factor SF1 is calculated according to the following equation (1).

SF-1={(MXLNG)²/AREA}×(π/4)×(100) (1)

wherein MXLNG represents an absolute maximum length of a particle, and AREA represents a projected area of the particle.

The spherical particles may also preferably have a specific surface area of 10 m²/g or less as the value measured according to JIS Z8830 (2001). As long as the spherical particles have a specific surface area of 10 m²/g or less, the elastic layer can be kept from having any excess hardness when the spherical particles are compounded into the base polymer.

The spherical particles may make use of any of silica, alumina and zirconia alone, or may be used in the form of a mixture of two or more types of these. The spherical particles may be contained in the elastic layer in an amount of approximately from 10 parts by mass or more to 100 parts by mass or less, based on 100 parts by mass of the base polymer. As long as the spherical particles are in a content of 10 parts by mass or more, the spherical particles can be made to be exposed in part to the surface of the elastic layer in the quantity that is sufficient for making the surface of the elastic layer roughened. Also, inasmuch as the spherical particles are in a content of 100 parts by mass or less, the elastic layer can be kept from being excessively hard.

The elastic layer may preferably be incorporated with a conductive agent in order to control its electrical resistance. As the conductive agent, the following may be used, for example: Carbon materials such as carbon black and graphite; oxides such as titanium oxide and tin oxide; metals such as Cu and Ag; electron-conductive agents such as conductive particles made electrically conductive by coating particle surfaces with oxides or metals; inorganic ionic substances such as lithium perchlorate, sodium perchlorate and calcium perchlorate; cationic surface-active agents such as lauryl trimethylammonium chloride, stearyl trimethylammonium chloride, octadecyl trimethylammonium chloride, dodecyl trimethylammonium chloride, hexadecyl trimethylammonium chloride, trioctyl propylammonium chloride, modified aliphatic dimethyl ethylammonium ethosulfate; amphoteric ionic surface-active agents such as lauryl betaine, stearyl betaine, and dimethylalkyl lauryl betaine; quaternary ammonium salts such as tetraethylammonium perchlorate, tetrabutylammonium perchlorate and trimethyloctadecylammonium perchlorate; and ion-conductive agents such as an organic-acid lithium salt such as lithium trifluoromethane sulfonate.

Any of these conductive agents may be used alone or in combination of two or more types. Any of these conductive agents may be in any content not particularly limited, as long as the charging member can be provided with the desired electrical conductivity. In order to form the surface layer in a thin film, it is preferable to make the elastic layer have a low electrical resistance. For example, the content of the conductive agent may preferably be so controlled that the elastic layer may have an electrical resistance of from 10²Ω or more to 10⁸Ω or less, and much preferably from 10³Ω or more to 10⁶Ω or less.

Besides, the elastic layer may optionally be incorporated with a filler, a processing aid, an antioxidant, a cross-linking agent, a cross-linking accelerator, a cross-linking accelerator activator, a cross-linking retarder, a dispersant and so forth as long as the function of the above substance is not inhibited.

The elastic layer may preferably have an Asker-C hardness of from 60 degrees or more to 85 degrees or less, and much preferably from 70 degrees or more to 80 degrees or less, in view of an advantage that the charging member is kept from deforming when the charging member and the photosensitive member are brought into contact with each other. The Asker-C hardness may be the value found by making measurement in a measuring environment of 25° C. and 55% RH under conditions of a load of 1,000 g, bringing a loaded needle of an Asker-C hardness meter (manufactured by Koubunshi Keiki Co., Ltd.) into touch with the surface of the measuring object.

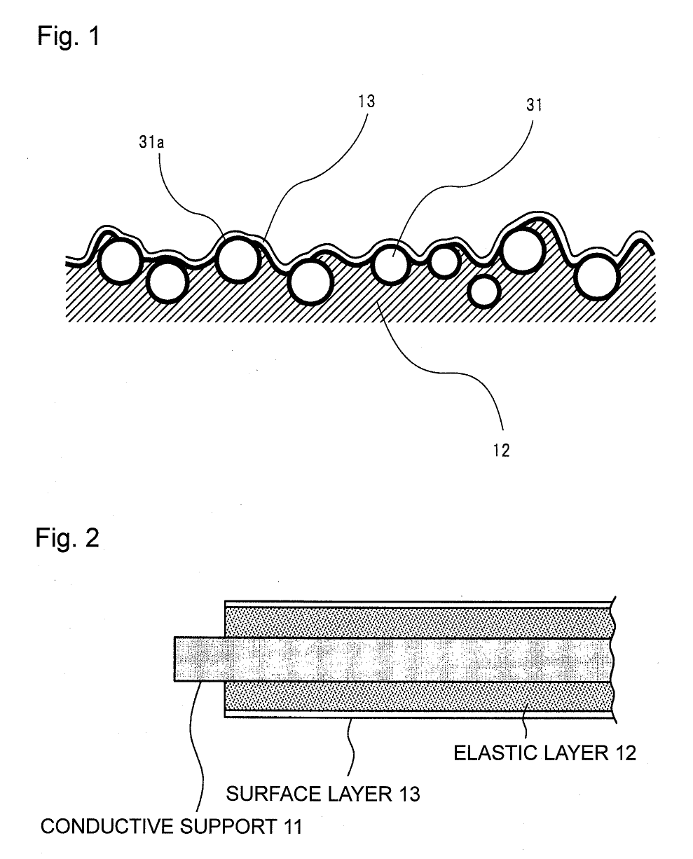

As described above, the elastic layer according to the present invention comprises the specific spherical particles in such a way that the spherical particles are exposed in part to the surface of the elastic layer. An enlarged cross section of the charging member of the present invention in the vicinity of its surface is diagrammatically shown in FIG. 1. In FIG. 1, exposed portions 31a of spherical particles 31 are not covered with the elastic layer, and protrude from the surface of the an elastic layer 12 as viewed in a scanning electron microscope image, so as to make the surface of the elastic layer roughened.

In the present invention, the surface of the elastic layer is what is inclusive of the surfaces of the exposed portions 31a of the spherical particles 31. Therefore, a state in which the surface of the elastic layer 12 is overlaid with a surface layer, detailed later, is meant by a state in which the surface layer 13 covers the whole surface of the elastic layer that is inclusive of the exposed portions 31a of the spherical particles 31.

How to form the elastic layer to the surface of which the spherical particles are exposed at least in part according to the present invention is described next.

First, materials constituting the elastic layer which are, stated specifically, the binder polymer, the spherical particles and optionally conductive particles are mixed by means of a closed mixing machine such as Banbury mixer or a pressure kneader or an open mixing machine such as an open roll to obtain a mixture for forming the elastic layer. Thereafter, the elastic layer may be formed on the conductive support by any of the following methods (1) to (3).

(1) A method in which the elastic layer forming mixture is extruded in the shape of a tube by means of an extruder and a mandrel is inserted thereinto.
(2) A method in which the elastic layer forming mixture is co-extruded in the shape of a cylinder around a mandrel by means of an extruder fitted with a cross head, so as to have the desired outer diameter.
(3) A method in which, using an injection molding machine, the elastic layer forming mixture is injected to the interior of a mold that provides the desired outer diameter, to prepare the elastic layer.

In particular, the method (2) is preferable because it facilitates continuous manufacture, has a small number of steps and is suited for production at a low cost.

Next, the surface of the elastic layer formed on the conductive support by carrying out any necessary heat curing treatment in accordance with the properties of the base polymer is sanded to make part of the spherical particles exposed to the surface of the elastic layer. As methods for grinding the surface of the elastic layer, usable are a traverse system in which a grinding wheel or an elastic roller on which the elastic layer has been formed is moved in the axial direction to carry out grinding, and a plunge-cut system in which a grinding wheel having a width larger than the length of the elastic roller to carry out grinding while the elastic roller is rotated.

The plunge-cut system has an advantage that the elastic roller can be ground at a time in its whole length, and is preferable because the time for working can be made shorter than that in the traverse system.

Further, since the surface layer formed on the surface of the elastic layer is a thin film, the surface condition of the elastic layer has a great influence on the surface of the charging member, and hence the surface of the elastic layer may preferably be treated by surface modification for, e.g., making the surface low frictional, from the viewpoint of the stabilization of its driving with the photosensitive member or the prevention of its staining with toner. As a method for the surface modification, it may be made by irradiation with ultraviolet rays, irradiation with electron rays, plasma treatment, corona discharge treatment or the like, and surface treatment by any of these may be made in combination.

<Surface Layer>

The surface layer contains a high-molecular compound having a constituent unit represented by the following formula (1). Such a high-molecular compound shows an excellent affinity for both the spherical, particles and the binder polymer that constitutes the surface of the elastic layer. The high-molecular compound also has a densely cross-linked structure, and hence shows a high rigidity. Hence, the spherical particles made exposed in part to the surface of the elastic layer can effectively be kept from coming off the surface of the charging member. As the result, the charging member according to the present invention can not easily change in its surface profile even because of its service over a long period of time. That is, the charging member according to the present invention can be what does not easily change with time in its charging performance.

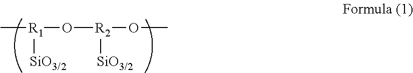

In the formula (1), R₁ and R₂ each independently represent any of structures represented by the following formulas (2) to (5).

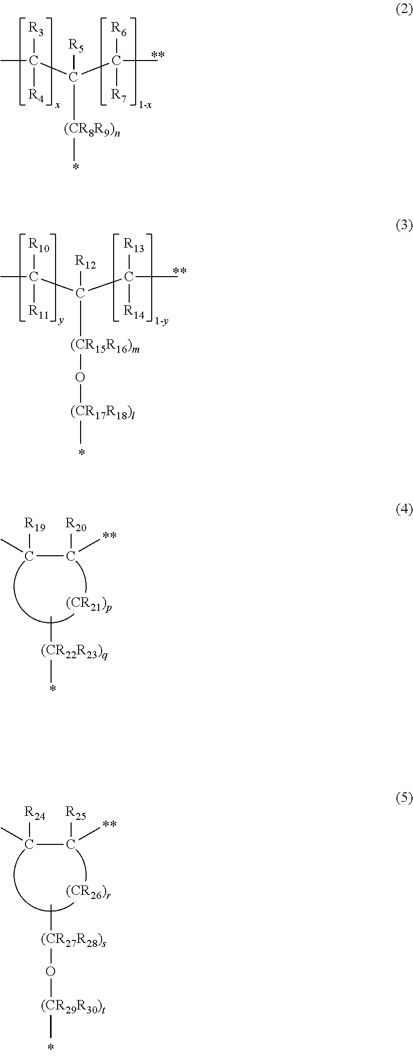

In the formulas (2) to (5), R₃ to R₇, R₁₀ to R₁₄, R₁₉, R₂₀, R₂₄ and R₂₅ each independently represent a hydrogen atom, an alkyl group having 1 to 4 carbon atom(s), a hydroxyl group, a carboxyl group or an amino group; R₈, R₉, R₁₅ to R₁₈, R₂₂, R₂₃ and R₂₇ to R₃₀ each independently represent a hydrogen atom or an alkyl group having 1 to 4 carbon atom(s); n, m, l, q, s and t each independently represent an integer of 1 to 8, p and r each independently represent an integer of 4 to 12, and x and y each independently represent 0 or 1; and a symbol “*” represents the position of bonding with the silicon atom in the formula (1), and a symbol “**” represents the position of bonding with the oxygen atom in the formula (1).

The structures represented by the formulas (2) to (5) may include as specific examples thereof those represented by the following formulas (6) to (9) in which R₃ to R₃₀ represent a hydrogen atom.

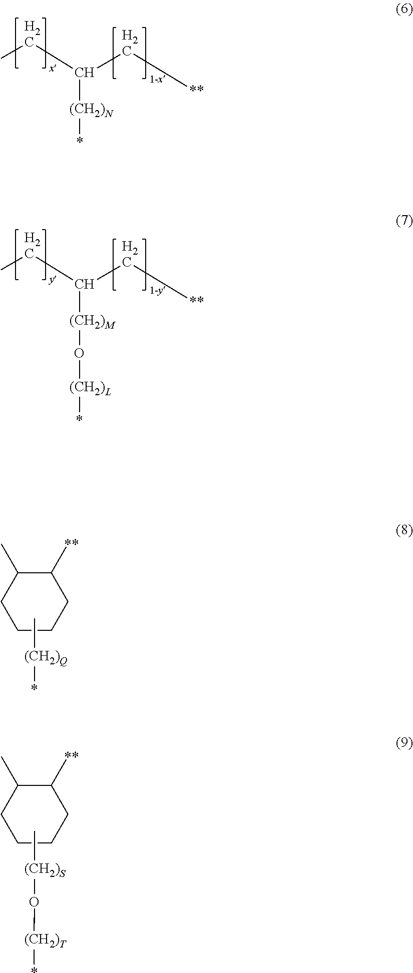

In the formulas (6) to (9), N, M, L, Q, S and T each independently represent an integer of 1 to 8, and x′ and y′ each independently represent 0 or 1; and a symbol “*” represents the position of bonding with the silicon atom in the formula (1), and a symbol “**” represents the position of bonding with the oxygen atom in the formula (1).

To form such a surface layer, a method may be employed in which a coating solution for forming the surface layer is prepared and this is coated on the elastic layer on which the exposed portions of the spherical particles have been formed, followed by irradiation with activated-energy rays to effect cross-linking. The surface layer coating solution may be prepared through the following steps (1) and (2).

Step (1):

The step of mixing an epoxy group-containing hydrolyzable silane compound (A) represented by the following formula (10) and optionally a hydrolyzable silane compound (B) represented by the following formula (11), and then, into the mixture obtained, further mixing water (D) and an alcohol (E), followed by heating and reflux to carry out hydrolysis condensation.

R₃₁—Si(OR₃₂)(OR₃₃)(OR₃₄) Formula (10)

R₆₃—Si(OR₆₄)(OR₆₅)(OR₆₆) Formula (11)

Step (2):

The step of adding a photopolymerization initiator (F) to the hydrolysis condensation product obtained through the step (1), and optionally diluting it with an alcohol (E).

In the epoxy group-containing hydrolyzable silane compound (A) represented by the formula (10), used in the step (1), R₃₂ to R₃₄ each independently represent a hydrocarbon group. The hydrocarbon group may include, e.g., an alkyl group, an alkenyl group and an aryl group. Of these, a straight-chain or branched-chain alkyl group having 1 to 4 carbon atom(s) is preferred, which may specifically include a methyl group, an ethyl group, an iso-propyl group, a n-butyl group and a t-butyl group. R₃₁ represents any of structures represented by the following formulas (12) to (15), having an epoxy group.

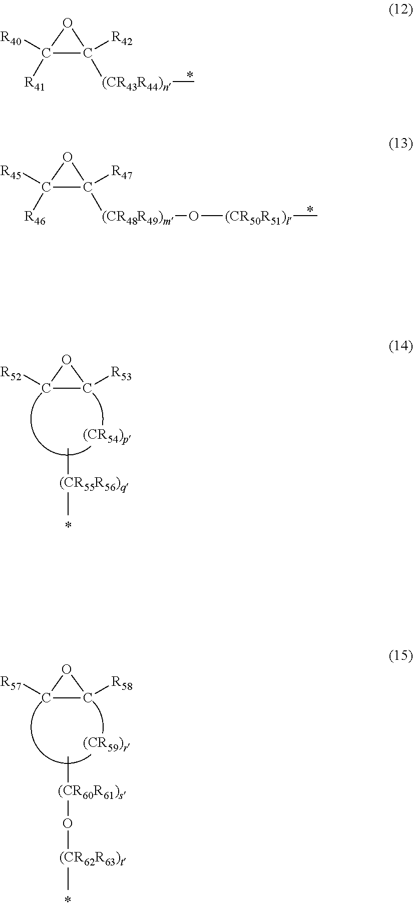

In the formulas (12) to (15), R₄₀ to R₄₂, R₄₅ to R₄₇, R₅₂, R₅₃, R₅₇ and R₅₈ each independently represent a hydrogen atom, an alkyl group having 1 to 4 carbon atom(s), a hydroxyl group, a carboxyl group or an amino group; R₄₃, R₄₄, R₄₈ to R₅₁, R₅₅, R₅₆ and R₆₀ to R₆₃ each independently represent a hydrogen atom or an alkyl group having 1 to 4 carbon atom(s); R₅₄ and R₅₉ each independently represent a hydrogen atom, an alkoxyl group having 1 to 4 carbon atom(s) or an alkyl group having 1 to 4 carbon atom(s), n′, m′, q′, s′ and t′ each independently represent an integer of 1 to 8, p′ and r′ each independently represent an integer of 4 to 12; and an asterisk * represents the position of bonding with the silicon atom.

The epoxy group-containing hydrolyzable silane compound (A) may specifically include the following, any of these may be used alone or in combination of two or more types: 4-(Trimethoxysilyl)butane-1,2-epoxide, 5,6-epoxyhexyltriethoxysilane, 8-oxysilan-2-yl octyltrimethoxysilane, 8-oxysilan-2-yl octyltriethoxysilane, 3-glycidoxypropyltrimethoxysilane, 3-glycidoxypropyltriethoxysilane, 1-(2-triethoxysilyl)methylcyclohexane-3,4-epoxide, 1-(2-triethoxysilyl)ethylcyclohexane-3,4-epoxide, and 3-(3,4-epoxycyclohexyl)methyloxypropyltrimethoxysilane.

In the hydrolyzable silane compound (B) represented by the formula (11), used in the step (1), R₆₄ represents an alkyl group or an aryl group, and R₆₅ to R₆₇ each independently represent a hydrocarbon group. As the R₆₄ alkyl group, a straight-chain alkyl group having 1 to 21 carbon atom(s) is preferred, and a straight-chain alkyl group having 6 to 10 carbon atoms is much preferred. As the R₆₄ aryl group, a phenyl group is preferred. As the R₆₅ to R₆₇ hydrocarbon group, it may include, e.g., an alkyl group, an alkenyl group and an aryl group. Of these, a straight-chain or branched-chain alkyl group having 1 to 4 carbon atom(s) is preferred, which may specifically include a methyl group, an ethyl group, a n-propyl group, an iso-propyl group, a n-butyl group and a t-butyl group. Also, where the surface layer coating solution contains a hydrolyzable silane compound wherein R₆₄ is a phenyl group, a hydrolyzable silane compound wherein R₆₄ is a straight-chain alkyl group having 6 to 10 carbon atoms may be used in combination, and this is preferable because such a compound is well compatible with solvents even when its structure changes through the hydrolysis condensation reaction.

The hydrolyzable silane compound (B) may include as specific examples thereof the following: Methyltrimethoxysilane, methyltriethoxysilane, ethyltrimethoxysilane, ethyltriethoxysilane, propyltrimethoxysilane, propyltriethoxysilane, hexyltrimethoxysilane, hexyltriethoxysilane, hexyltripropoxysilane, decyltrimethoxysilane, decyltriethoxysilane, phenyltrimethoxysilane, phenyltriethoxysilane, phenyltripropoxysilane and octyltriethoxysilane.

As the hydrolyzable silane compound (B), two or more compounds selected from the group of compounds listed in the above specific examples may be used in combination. A compound wherein at least one hydrogen atom of the alkyl group in any of the compounds listed in the above specific examples has been substituted with a fluorine atom may also be used as the hydrolyzable silane compound (B).

The water (D) as used in the step (1) may preferably be added in such an amount that the ratio of the total number of moles of the hydrolyzable silane compounds (A) and (B), (A)+(B), to the number of moles of the water, (D), i.e., R_{OR}=(D)/[(A)+(B)] is from 0.3 or more to 6.0 or less. It is much preferable that the R_{OR} is from 1.2 or more to 3.0 or less. As long as the R_{OR} is 0.3 or more, the condensation reaction is sufficiently effected, and any unreacted silica compound can be kept from remaining in the surface layer coating solution, so that a film having a high crosslink density can be obtained. As long as the R_{OR} is 6.0 or less, the condensation reaction proceeds at a high rate, and the surface layer coating solution can be kept from coming to be milky or precipitate and also can be kept from becoming highly polar to come to be low compatible with the condensation product.

The alcohol (E) is used in order to compatibilize the hydrolysis condensation products of the hydrolyzable silane compounds (A) and (B). As the alcohol (E), it is preferable to use a primary alcohol, a secondary alcohol, a tertiary alcohol, a mixed system of a primary alcohol and a secondary alcohol, or a mixed system of a primary alcohol and a tertiary alcohol. As the alcohol, particularly preferred is ethanol, a mixed solution of methanol and 2-butanol, or a mixed solution of ethanol and 2-butanol.

In the step (1), these are mixed, and then heated and refluxed to form a hydrolysis condensation product. In the step (1), one or two or more types of the hydrolyzable silane compound (A) may be used optionally in combination with one or two or more types of the hydrolyzable silane compound (B), and a metal alkoxide (C) may further be used. As the metal alkoxide (C), it may preferably be zirconium, hafnium, tantalum or titanium to which an alkoxyl group(s) has/have been bonded in the number corresponding to the former's valence.

The alkoxyl group may include, e.g., an alkyloxyl group, an alkenyloxyl group and an aryloxyl group, and may also be an alkoxyl group part of the carbon atoms of which has been substituted with an oxygen atom or a nitrogen atom. Stated specifically, it may include a methoxyl group, an ethoxyl group, a n-propoxyl group, an iso-propoxyl group, a n-butoxyl group and a t-butoxyl group.

The metal alkoxide (C) may be used in an amount of (C)/[(A)+(B)]≦5.0 in molar ratio, and this is preferable because the surface layer coating solution can be kept from coming to be milky or precipitate and can be improved in storage stability. The metal alkoxide (C) may further preferably be used in an amount of 0.5(C)/[(A)+(B)]≦3.0.

The metal alkoxide (C) may preferably be added to a hydrolysis condensation product formed after the water (D) and the alcohol (E) are added to the hydrolyzable silane compound (A) or the mixture thereof with the hydrolyzable silane compound (B) to form the hydrolysis condensation product.

The photopolymerization initiator (F) used in the step (2) is used in order to form a crosslink in a silane condensation product. As the photopolymerization initiator (G), an onium salt of Lewis acid or Brønsted acid, or a cationic polymerization catalyst may be used. The cationic polymerization catalyst may include, e.g., borate salts, imide compounds, triazine compounds, azo compounds, and peroxides. As the cationic polymerization catalyst, an aromatic sulfonium salt or an aromatic iodonium salt is preferred from the viewpoint of sensitivity, stability and reactivity. As a particularly preferable cationic polymerization catalyst, it may include bis(4-tert-butylphenyl) iodonium salt and a compound represented by the formula (16) (trade name: ADECAOPTOMER SP150; available from Asahi Denka Kogyo K.K.).

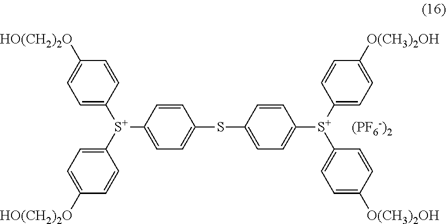

A compound represented by the formula (17) (trade name: IRGACURE 261; available from Ciba Specialty Chemicals Inc.) may also preferably be used.

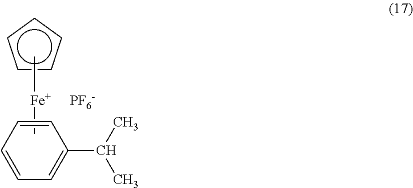

The photopolymerization initiator (G) may preferably be used in the state it is previously dissolved in a solvent such as an alcohol or a ketone, as exemplified by methanol or methyl isobutyl ketone, so as to be improved in compatibility with the surface layer coating solution.

Further, the surface layer coating solution may preferably be controlled to have a concentration suited to coating, so as to be improved in its coating performance. The lower viscosity the surface layer coating solution has, the smaller layer thickness the surface layer can be made to have to make the surface layer have a larger capacitance. Hence, the charging member can sufficiently secure charge quantity on its surface, can be kept from discharge non-uniformity, and can charge the photosensitive member more uniformly. Hence, it is preferable to make the coating solution have a low viscosity by using a solvent appropriately. On that occasion, the coating solution may further preferably have a viscosity of 2 mPa·s or less as a value measured with a B-type viscometer. As the solvent used, the same alcohol as the alcohol used in the step (1) may be used. Besides, ethyl acetate or a ketone such as methyl ethyl ketone or methyl isobutyl ketone may also be used, and may be used in the form of a mixture of any of these. Of these, methanol is particularly preferred. The surface layer coating solution having been controlled in this way may be coated on the elastic layer by a method such as spray coating, ring coating, or coating making use of a roll coater.

A coating film formed on the elastic layer in the above way may be irradiated with activated-energy rays to produce radicals of the photopolymerization initiator (G), so as to cause cleavage of the epoxy group and polymerization to form a crosslink. As the activated-energy rays, ultraviolet rays are preferable because they can produce the radicals of the photopolymerization initiator (G) to make the cross-linking reaction proceed, at a low temperature.

Making the cross-linking reaction proceed at a low temperature can keep the solvent from rapidly volatilizing from a coating and keep the coating from coming to undergo phase separation to wrinkle, thus a surface layer can be formed which has a high strength of bond with the elastic layer. Such a surface layer having a high strength of bond with the elastic layer can be kept from coming to wrinkle or crack, even if the charging member is used in an environment involving any abrupt changes in temperature and humidity and the elastic layer varies in volume because of such changes in temperature and humidity. In addition, the elastic layer can be kept from thermally deteriorating when the cross-linking reaction proceeds, and hence the elastic layer can also be kept from lowering in its electrical properties.

As a radiation source of ultraviolet rays, a high-pressure mercury lamp, a metal halide lamp, a low-pressure mercury lamp, an excimer UV lamp or the like may be used. Of these, a source is preferred which emits ultraviolet rays of from 150 nm or more to 480 nm or less in wavelength. The irradiation with ultraviolet rays may be made under control of integral light quantity by selecting irradiation time, lamp output, and distance between the lamp and the irradiation object. The irradiation quantity of ultraviolet rays may also be sloped within the irradiation time. The ultraviolet rays may preferably be in an integral light quantity of about 8,000 mJ/cm². The integral light quantity of ultraviolet rays may be determined from the following expression. Integral light quantity (mJ/cm²) of ultraviolet rays=ultraviolet radiation intensity (mW/cm²)×irradiation time (s).

Where the low-pressure mercury lamp is used, the integral light quantity of the ultraviolet rays may be measured with an ultraviolet radiation integral light quantity meter UIT-150-A or UVD-S254 (both are trade names), manufactured by Ushio Inc. Where the excimer UV lamp is used, the integral light quantity of the ultraviolet rays may be measured with an ultraviolet radiation integral light quantity meter UIT-150-A or VUV-S172 (both are trade names), manufactured by Ushio Inc.

The surface layer according to the present invention covers the whole surface of the elastic layer that is inclusive of the exposed portions of the spherical particles. The elastic layer has a thickness that is smaller than the height of the exposed portions of the spherical particles. This makes the surface profile of the elastic layer reflected on the surface profile of the surface layer, i.e., on the surface profile of the charging member.

The thickness of the surface layer is not particularly limited as long as the surface profile of the elastic layer is reflected on the surface profile of the charging member. The surface layer may preferably have a thickness of approximately from 10 nm or more to 1 μm or less, and particularly preferably from 30 nm or more to 500 nm or less. Inasmuch as it has thickness within this range, the spherical particles can effectively be kept from coming off the charging member during its service. Also, the surface layer can be kept from deforming, and can be kept from increasing in its area of contact with the photosensitive member. As long as the surface layer has a thickness of 1 μm or less, it can have an appropriate capacitance, and can keep the charging member from being excessively hard, to enable formation of an appropriate nip zone between the charging member and the photosensitive member. The thickness of the surface layer may be measured by observation on an electron microscope.

According to the charging member of the present invention, the toner and so forth can effectively be kept from sticking fast to the surface of the electrophotographic photosensitive member, and contributes to the formation of high-grade electrophotographic images over a long period of time.

That is, studies made by the present inventors have revealed that, when the charging member according to the aforesaid PTL 2 is used for a long term, defects may occur in electrophotographic images. The cause thereof is still on studies, but has been presumed to be what is caused by the mechanism as stated below. That is, the surface layer containing a polysiloxane according to PTL 2 is dense and has a high hardness, and hence, at a nip zone between the charging member and the photosensitive member, the surface layer may inevitably press against the surface of the photosensitive member the toner that has enter the nip zone, so that any matter stuck-fast of the toner may gradually accumulate on the photosensitive member surface. Then, the toner adhering to the photosensitive member surface comes not to be removable even by cleaning with a cleaning blade. As the result, the defects occur in electrophotographic images, as so presumed.

On the other hand, the charging member according to the present invention has the surface profile on which the surface profile of the elastic layer having been made roughened is reflected. Then, the particles having a high hardness are used as the spherical particles and at the same time the surface layer contains the polysiloxane having a high rigidity. This makes the surface-roughened charging member not easily loose its surface profile. That is, the area of contact between the charging member and the photosensitive member at the nip comes smaller than the case in which the charging member according to PTL 2 is used.

Hence, the toner can not easily stick fast to the surface of the photosensitive member, and the surface of the photosensitive member can be kept from lowering with time in its cleanability. As the result, any image defects caused by the matter stuck-fast to the surface of the photosensitive member can be kept from occurring even where electrophotographic images have been formed on a large number of sheets.

The surface layer may preferably have a volume resistivity of from 10⁸ Ω·cm or more to 10¹⁵ Ω·cm or less, and particularly from 10¹⁰ Ω·cm or more to 10¹⁵ Ω·cm or less. Inasmuch as the surface layer has volume resistivity within this range, any abnormal discharge can be kept from occurring between the charging member and the photosensitive member, and at the same time the photosensitive member can more uniformly be charged.

The surface layer may also preferably have an elasticity of from 1,000 MPa or more to 2,000 MPa or less. Inasmuch as the surface layer has elasticity within this range, the nip can be formed in an appropriate width between the charging member and the photosensitive member. Also, the surface layer can be kept from so deforming as to make the spherical particles embedded in the elastic layer, and can be kept from increasing in its area of contact with the photosensitive member. Still also, even such a surface layer having thickness as described above can well follow up any deformation of the flexible elastic layer.

The charging member of the present invention is not particularly limited, as long as it is one having on the substrate the elastic layer and the surface layer further thereon, and may have any other layer(s) between the substrate and the elastic layer and/or between the elastic layer and the surface layer. As an example of the charging member of the present invention, a roller-shaped charging member is shown in FIG. 2 sectional view. A charging roller 10 in this example has a structure wherein an elastic layer 12 and a surface layer are superposed in this order on a conductive support 11.

<Electrophotographic Apparatus>

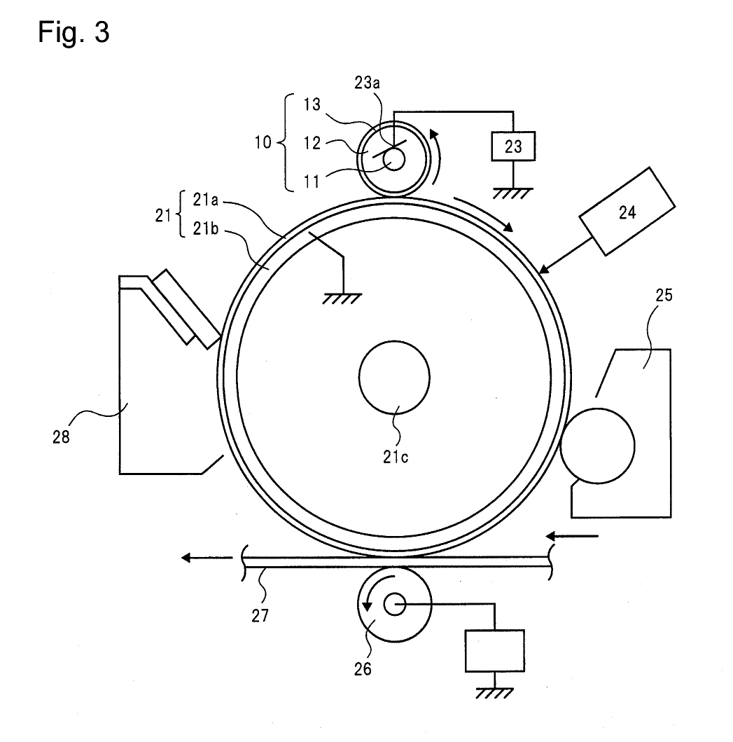

An example of the electrophotographic apparatus having the charging member of the present invention is shown in FIG. 3. In FIG. 3, reference numeral 21 denotes a cylindrical photosensitive member, which has a support 21b and a photosensitive layer 21a formed on the support, and is rotatingly driven around a shaft 21c in the direction of an arrow at a stated peripheral speed.

The above charging roller 10 is so disposed as to be pressed against the surface of the photosensitive member being rotatingly driven and is follow-up rotated with the photosensitive member 21 in contact therewith. To the charging roller 10, a stated direct-current (DC) bias is applied by electric energy supplied through a rubbing-friction electrode 23a from a power source 23 connected to the conductive support 11, whereupon the photosensitive member pressed against the charging roller 10 to form a nip zone therebetween is electrostatically charged to a stated potential in the vicinity of the nip zone.

The photosensitive member thus charged is then exposed to exposure light emitted from an exposure means 24 for slit exposure or laser beam scanning exposure. Thus, electrostatic latent images corresponding to the intended image are successively formed on the photosensitive layer 21a of the photosensitive member. A toner is fed by a developing member 25 to the electrostatic latent images formed on the photosensitive member, whereupon toner images are formed thereon. The toner images on the photosensitive member are then successively transferred to a transfer material 27 such as paper having been transported from a transfer material feed means (not shown) to the part of contact between the photosensitive member and a transfer means 26 in the manner synchronized with the rotation of the photosensitive member.

The transfer material to which the toner images have been transferred is separated from the surface of the photosensitive member, is guided into a fixing means, where the toner images are fixed, and is then put out of the apparatus as an image-formed material (a print or a copy). The surface of the photosensitive member from which the toner images have been transferred is brought to removal of the developer (toner) remaining after the transfer, through a cleaning means 28 having a cleaning blade, thus it is made into a cleaned surface.

In the charging member of the present invention, the elastic layer comprises the high-hardness spherical particles selected from silica, alumina and zirconia particles, in such a way that they are exposed in part to the surface of the elastic layer, the surface of which stands roughened by such particles through the thin-film surface layer. The surface layer has a high adherence to both the spherical particles and the elastic layer and also has a high modulus of elasticity. Hence, it holds the spherical particles in such a way as to cover the whole surface of the elastic layer, and, at the nip formed when the charging member is pressed against the photosensitive member, can maintain the spherical particles standing exposed to the elastic layer surface. In virtue of this, the charging member can maintain its unevenness profile to keep the area of contact between the charging member and the photosensitive member from increasing. The surface layer is a thin film, and the charging member can maintain the low hardness of the elastic layer to form a sufficient nip zone between it and the photosensitive member, thus any faulty images due to faulty contact between them and any running faulty images caused by the adhering of the toner and external additives to the charging member surface can be kept from occurring.

### EXAMPLES

The present invention is described below in greater detail by giving specific working examples. In the following, “part(s)” refers to “part(s) by mass”. As reagents and the like, commercially available high-purity products are used unless particularly specified.

### Example 1

### Formation of Elastic Layer

Materials shown in Table 1 below were mixed by means of a 6-liter pressure kneader (product name: TD6-15MDX; manufactured by Toshin Co., Ltd.) for 16 minutes in a packing of 70 vol. % and at a number of blade revolutions of 30 rpm to obtain a first-stage kneaded rubber composition.

TABLE 1

| | |
|---|---|
| NBR (trade name: JSR N230SV; | 100 parts |
| available from JSR Corporation) as | |
| raw-material rubber, | |
| Zinc stearate as processing aid | 1 part |
| Zinc oxide as vulcanization | 5 parts |
| accelerator activator | |
| Calcium carbonate (trade name: NANOX | 20 parts |
| #30; available from Maruo Calcium | |
| Co., Ltd.) as filler | |
| Carbon black (trade name: TOKA BLACK | 45 parts |
| #7360SB; available from Tokai Carbon | |
| Co., Ltd.) as conductive agent | |
| Spherical silica particles 1 (trade | 40 parts |
| name: FB-20D; available from Denki | |
| Kagaku Kogyo Kabushiki Kaisha) as | |
| spherical particles | |

Next, materials shown in Table 2 below were mixed by means of an open roll of 12 inches in roll diameter at a number of front-roll revolutions of 8 rpm and a number of back-roll revolutions of 10 rpm and at a roll gap of 2 mm, carrying out right and left 20 cuts in total. Thereafter, the roll gap was changed to 0.5 mm to carry out tailing 10 times to obtain an unvulcanized rubber composition for forming an elastic layer.

TABLE 2

| | |
|---|---|
| First-stage kneaded rubber | 211 parts |
| composition obtained above | |
| Sulfur as cross-linking agent | 1.2 parts |
| Tetrabenzylthiuram disulfide (trade | 4.5 parts |
| name: PERKACIT-TBzTD; available from | |
| Flexsys Co.) as vulcanization | |
| accelerator | |

A columnar mandrel (made of steel and plated with nickel on its surface) of 6 mm in diameter and 252 mm in length was coated with a conductive vulcanization adhesive (METALOC U-20, available from Toyokagaku Kenkyusho Co., Ltd.) over the column surface on its middle portion of 226 mm in axial direction, followed by drying at 80° C. for minutes. Next, the above unvulcanized rubber composition was extruded together with the mandrel while being shaped coaxially around the mandrel and in the shape of a cylinder, by extrusion making use of a cross head, to produce an unvulcanized rubber roller of 8.8 mm in diameter which was coated with the unvulcanized rubber composition on the outer periphery of the mandrel. As an extruder, an extruder having a cylinder diameter of 45 mm and an L/D of 20 was used, making temperature control to 90° C. for ahead, 90° C. for a cylinder and 90° C. for a screw at the time of extrusion.

The unvulcanized rubber roller thus shaped was cut at both end portions to make its elastic layer portion be 228 mm in width in its axial length. Thereafter, this was heated at 160° C. for 40 minutes by means of an electric furnace to obtain a vulcanized rubber layer. The vulcanized rubber roller obtained was sanded on its surface by means of a sander of a plunge-cut grinding system to obtain a rubber roller having an elastic layer with a crown shape of 8.35 mm in end-portion diameter and 8.50 mm in middle-portion diameter.

Formation of Surface Layer:

Materials shown in Table 3 below were mixed, and then stirred at room temperature, followed by heating and reflux for 24 hours to obtain a condensation product sol 1 of an organic-inorganic hybrid sol.

TABLE 3

| | |
|---|---|
| Glycidoxypropyltrimethoxysilane | 27.84 g (0.1 mol) |
| (GPTES) | |
| Methyltriethoxysilane (MTES) | 17.83 g (0.1 mol) |
| Tridecafluoro-1,1,2,2- | 7.68 g |
| tetrahydrooctyltriethoxysilane (FTS; | (0.0151 mol, corr. |
| perfluoroalkyl group: 6 carbon atoms) | to 7 mol % based |
| | on total mass of |
| | hydrolyzable |
| | silane compound) |
| Water | 17.43 g |
| Ethanol | 37.88 g |

This condensation product sol 1 was added to a 2-butanol/ethanol mixed solvent to prepare a condensation product sol fluid 1 having 7% by mass of solid content. Incidentally, the solid content is a condensation product formed when the hydrolyzable silane compound has completely undergone dehydration condensation. In the following, the solid content is used in the same meaning unless particularly noted.

To 100 g of this condensation product sol fluid 1, an aromatic sulfonium salt (trade name: ADECAOPTOMER SP-150; available from Asahi Denka Kogyo K.K.) as a cationic photopolymerization catalyst was added in a proportion of 0.35 g to obtain a coating stock solution 1.

The coating stock solution 1 was so diluted with a 2-butanol/ethanol mixed solvent as to have a solid content of 4.5% by mass, to make up a surface layer forming coating solution 1. The viscosity of the surface layer forming coating solution 1 was measured with a B-type viscometer (RE500L, manufactured by Toki Sangyo Co., Ltd.; making use of 0.8°×R24 cone rotor) to find that it was 1 mPa·s or less. It was measured under conditions of a measurement temperature of 25° C. and a sample weight of 0.6 ml.

Next, the rubber roller was coated on its elastic layer with the surface layer forming coating solution 1 by ring coating (ejection rate: 0.120 ml/s; moving rate of ring head: 85 mm/s; total delivery: 0.130 ml).

Next, using a low-pressure mercury lamp (manufactured by Harison Toshiba Lighting Corporation), the rubber roller on which a coating film of the surface layer forming coating solution 1 was formed was, while being rotated, so irradiated with ultraviolet rays that the amount of light of ultraviolet radiation came to 8,000 mJ/cm² as sensitivity in a 254 nm sensor, to cure the coating film. Thus, a charging roller 1 was produced the surface of the elastic layer of which was overlaid with a surface layer having an unevenness-shaped surface profile as the surface profile of the elastic layer was reflected thereon. The durability of charging performance of the charging roller 1 and the physical properties of its surface layer were evaluated and measured in the following way.

Image Evaluation:

A laser beam printer (trade name: LASER JET P1005; manufactured by Hewlett-Packard Co.) practicable for A4-size sheet lengthwise printing was readied as an electrophotographic apparatus used in image formation. The charging roller produced as above was set in a process cartridge for this laser beam printer, and this process cartridge was mounted to the electrophotographic apparatus.

To a mandrel of the charging roller, a DC voltage of −120 V was applied by using an external power source (MODEL PM04015A, manufactured by Trek Japan Co., Ltd.), where, in an environment of temperature 23° C. and relative humidity 50%, halftone images having solid images partly (images in which lines each being 1 dot in width were drawn at intervals of and 2 dots in the direction perpendicular to the rotational direction of an electrophotographic photosensitive member) were formed on one sheet. Subsequently, electrophotographic images of 1% in print density were formed on 2,500 sheets. Further subsequently, the same halftone images having solid images partly as those for the 1st sheet were formed on one sheet. Here, the images were formed in what is called an intermittent mode in which the photosensitive drum was completely stopped for each printing on one sheet.

Evaluation 1: Evaluation on any Image Defects Caused by Faulty Cleaning of Photosensitive Member Surface:

About the 1st sheet to 1,000th sheet among the 2,500 sheets of electrophotographic images of 1% in print density, the images were visually observed to make evaluation according to the following criteria.

A: Any image defects caused by faulty cleaning of the photosensitive member surface are not seen on all the 1,000 sheets of electrophotographic images.
B: Slight image defects caused by faulty cleaning of the photosensitive member surface are seen, but the rate of defects occurring on every 100 sheets is always 5% or less.
C: Image defects caused by faulty cleaning of the photosensitive member surface are seen, but the rate of defects occurring on every 100 sheets is always 5% or less.
D: Image defects caused by faulty cleaning of the photosensitive member surface are seen, and the rate of defects occurring on every 100 sheets is more than 5% in some cases.

Evaluation 2: Evaluation of Charging Performance:

The halftone images having solid images partly were visually observed on those formed on the 1st sheet and the 2,501st sheet, and whether or not and how much any image defects caused by non-uniform charging occurred was observed to make evaluation according to the following criteria.

A: Any density non-uniformity in horizontal lines which is caused by non-uniform charging is not seen or little seen.
B: Density non-uniformity in horizontal lines which is caused by non-uniform charging can be seen in the halftone image areas.
C: Density non-uniformity in horizontal lines which is caused by non-uniform charging can clearly be seen in the halftone image areas and solid image areas.

Measurement 1: Modulus of Elasticity of Surface Layer:

An aluminum sheet of 100 μm in thickness was coated on its degreased surface with the surface layer forming coating solution 1 to form a coating film. After drying, the coating film was irradiated with ultraviolet rays under the same conditions as those in producing the charging roller (at a wavelength of 254 nm and in an integral light quantity of 8,000 mJ/cm²) to obtain a cured film of 10 μm or more in thickness.

About the cured film obtained, using a surface film physical properties tester (trade name: FISCHER SCOPE H100V; manufactured by Fischer Instruments K.K.), the value found when an indenter was penetrated from the surface of the measuring object at a rate of 1 μm/7 seconds was measured, and this value was taken as the modulus of elasticity.

On this occasion, it was also ascertained that the structure of the formula (1) was contained in the cured film. Incidentally, with regard to surface layer forming coating solutions 5 and 6, coating films having been dried were irradiated with ultraviolet rays after their heat treatment at a temperature of 160° C. for 1 hour.

Measurement 2: Layer Thickness of Surface Layer:

The charging roller was sectionally cut with a knife, and layer thickness was measured in an image of its section observed on a scanning transmission electron microscope (HD-2000, manufactured by Hitachi High-Technologies Corporation).

### Example 2

The coating stock solution 1, prepared in the same way as Example 1, was so diluted with a 2-butanol/ethanol mixed solvent as to have a solid content of 0.5% by mass, to prepare a surface layer forming coating solution 2. The surface layer forming coating solution 2 had a viscosity of 1 mPa·s or less.

A charging roller was produced in the same way as Example 1 except that the surface layer forming coating solution 2 was used instead. This charging roller and its surface layer were evaluated in the same way as Example 1.

### Example 3

A rubber roller was produced in the same way as Example 1 except that the spherical particles shown in Table 1 in Example 1 were changed for 10 parts by mass of spherical silica particles 2 (trade name: HS-301; available from Denki Kagaku Micron Inc.).

The coating stock solution 1, prepared in the same way as Example 1, was so diluted with a 2-butanol/ethanol mixed solvent as to have a solid content of 1.5% by mass, to prepare a surface layer forming coating solution 3. The surface layer forming coating solution 3 had a viscosity of 1 mPa·s or less.

On the surface of the elastic layer of the rubber roller obtained as above, a coating film of the surface layer forming coating solution 3 was formed and cured in the same way as Example 1. Thus, a charging roller was produced the surface of the elastic layer of which was overlaid with a surface layer having a surface profile on which the surface profile of the elastic layer was reflected. This charging roller and its surface layer were evaluated in the same way as Example 1.

### Example 4

A charging roller was produced in the same way as Example 1 except that the spherical particles used in the elastic layer were compounded in an amount changed to 80 parts by mass. This charging roller and its surface layer were evaluated in the same way as Example 1.

### Example 5

The condensation product sol fluid or liquid 1 as prepared in Example 1 was added to a 2-butanol/ethanol mixed solvent to prepare a condensation product sol fluid 2 having 14% by mass of solid content.

To 100 g of this condensation product sol fluid 2, an aromatic sulfonium salt (trade name: ADECAOPTOMER SP-150; available from Asahi Denka Kogyo K.K.) as a cationic photopolymerization catalyst was added in a proportion of 0.7 g to obtain a surface layer forming coating solution 4.

A rubber roller formed in the same way as Example 1 was coated on its surface with the surface layer forming coating solution 4 by dip coating to cover the surface of the elastic layer with a coating film of the surface layer forming coating solution 4. Here, the dipping time was 9 seconds, and dipping draw-up rates were 20 mm/s in initial rate and 2 mm/s in final rate, during which the draw-up rates were linearly changed with respect to time.

Next, this coating film was cured in the same way as Example 1 to form the surface layer, thus a charging roller was produced. This charging roller and its surface layer were evaluated in the same way as Example 1.

### Example 6

A charging roller was produced in the same way as Example 1 except that the spherical particles used in the elastic layer were compounded in an amount changed to 10 parts by mass. This charging roller and its surface layer were evaluated in the same way as Example 1.

### Example 7

A rubber roller was produced in the same way as Example 1 except that the spherical particles used in the elastic layer were changed for 10 parts by mass of spherical silica particles 3 (trade name: FB-40S; available from Denki Kagaku Kogyo Kabushiki Kaisha).

To 100 g of the condensation product sol fluid 1, prepared in the same way as Example 1, an aromatic sulfonium salt (trade name: ADECAOPTOMER SP-150; available from Asahi Denka Kogyo K.K.) as a cationic photopolymerization catalyst was so added as to be in a proportion of 1.4 g to prepare a surface layer forming coating solution 5. On the surface of the above rubber roller, a surface layer was formed in the same way as Example 1 except that the surface layer forming coating solution 5 was used instead, to produce a charging roller. This charging roller and its surface layer were evaluated in the same way as Example 1.

### Example 8

A charging roller was produced in the same way as Example 3 except that the spherical particles used in the elastic layer were changed for the spherical silica particles 3. This charging roller and its surface layer were evaluated in the same way as Example 1.

### Example 9

A charging roller was produced in the same way as Example 8 except that the spherical particles used in the elastic layer were compounded in an amount changed to 80 parts by mass. This charging roller and its surface layer were evaluated in the same way as Example 1.

### Example 10

A charging roller was produced in the same way as Example 5 except that the spherical particles used in the elastic layer were changed for the spherical silica particles 3. This charging roller and its surface layer were evaluated in the same way as Example 1.

### Example 11

A charging roller was produced in the same way as Example 3 except that the spherical particles used in the elastic layer were changed for spherical silica particles 4 (trade name: HS-305; available from Micron Inc.). This charging roller and its surface layer were evaluated in the same way as Example 1.

### Example 12

A charging roller was produced in the same way as Example 1 except that the spherical particles used in the elastic layer were changed for spherical alumina particles 1 (trade name: AY-118; available from Micron Inc.). This charging roller and its surface layer were evaluated in the same way as Example 1.

### Example 13

A charging roller was produced in the same way as Example 3 except that the spherical particles used in the elastic layer were changed for spherical alumina particles 2 (trade name: AX3-32; available from Micron Inc.). This charging roller and its surface layer were evaluated in the same way as Example 1.

### Example 14

A charging roller was produced in the same way as Example 13 except that the spherical particles used in the elastic layer were compounded in an amount changed to 80 parts by mass. This charging roller and its surface layer were evaluated in the same way as Example 1.

### Example 15

A charging roller was produced in the same way as Example 5 except that the spherical particles used in the elastic layer were changed for the spherical alumina particles 1. This charging roller and its surface layer were evaluated in the same way as Example 1.

### Example 16

A charging roller was produced in the same way as Example 5 except that, as the spherical particles used in the elastic layer, the spherical alumina particles 2 was used in an amount of 10 parts by mass. This charging roller and its surface layer were evaluated in the same way as Example 1.

### Example 17

A charging roller was produced in the same way as Example 1 except that the spherical particles used in the elastic layer were changed for spherical zirconia particles 1 (trade name: NS Beads; available from Niimi Sangyo Co., Ltd.). This charging roller and its surface layer were evaluated in the same way as Example 1.

### Example 18

A charging roller was produced in the same way as Example 5 except that, as the spherical particles used in the elastic layer, the spherical zirconia particles 1 was used in an amount of 100 parts by mass. This charging roller and its surface layer were evaluated in the same way as Example 1.

### Example 19

A charging roller was produced in the same way as Example 3 except that the spherical particles used in the elastic layer were changed for the spherical zirconia particles 1. This charging roller and its surface layer were evaluated in the same way as Example 1.

### Example 20

A surface layer forming coating solution was prepared in the following way.

Materials shown in Table 4 below were mixed, and then stirred at room temperature for 30 minutes, followed by heating and reflux at 120° C. for 20 hours by using an oil bath, to obtain a condensation product sol 2 having a solid content of 28.0% by mass.

TABLE 4

| | |
|---|---|
| Glycidoxypropyltrimethoxysilane | 11.56 g (0.049 mol) |
| (hydrolyzable silane compound; trade | |
| name: KBM-403; available from | |
| Shin-Etsu Chemical Co., Ltd.) | |
| Hexyltrimethoxysilane (hydrolyzable | 62.11 g (0.302 mol) |
| silane compound; trade name: KBM- | |
| 3036; available from Shin-Etsu | |
| Chemical Co., Ltd.) | |
| Ethanol (guaranteed; available from | 91.87 g |
| Kishida Chemical Co., Ltd.) | |
| Ion-exchanged water | 11.34 g |

Next, the condensation product sol 2 was cooled to room temperature. To 98.05 g of the same, 78.75 g (0.149 mol) of tantalum pentaethoxide (available from Gelest, Inc.) was added, and the mixture obtained was stirred at room temperature for 3 hours to obtain a condensation product sol fluid 3. A sequence of stirring was carried out at a speed of 750 rpm. Ta/Si=1.0.

To 25 g of this condensation product sol fluid 2, as a cationic photopolymerization catalyst an aromatic sulfonium salt (trade name: ADECAOPTOMER SP-150; available from Asahi Denka Kogyo K.K.) diluted with methyl isobutyl ketone to 10% by mass was added in an amount of 2.00 g to obtain a coating stock solution 2. This coating stock solution 2 was so diluted with a 1:1 (mass ratio) ethanol/2-butanol mixed solvent as to have a solid content of 2.0% by mass, to obtain a surface layer forming coating solution 6. A charging roller was produced in the same way as Example 1 except that this surface layer forming coating solution 6 was used instead. This charging roller and its surface layer were evaluated in the same way as Example 1.

### Example 21

A surface layer forming coating solution was prepared in the following way.

At room temperature, 113.16 g of a condensation product sol prepared in the same way as Example 1 was mixed with 63.64 g (0.224 mol) of titanium (IV) isopropoxide (available from High Purity Chemicals Co., Ltd.), and the mixture obtained was stirred at room temperature for 3 hours to obtain a condensation product sol fluid 4. A sequence of stirring was carried out at a speed of 750 rpm. Ti/Si=1.0.

To 25 g of this condensation product sol fluid 4, as a cationic photopolymerization catalyst an aromatic sulfonium salt (trade name: ADECAOPTOMER SP-150; available from Asahi Denka Kogyo K.K.) diluted with methyl isobutyl ketone to 10% by mass was added in an amount of 2.00 g to obtain a coating stock solution 3. This coating stock solution 3 was so diluted with a 1:1 (mass ratio) ethanol/2-butanol mixed solvent as to have a solid content of 2.0% by mass, to obtain a surface layer forming coating solution 7. A charging roller was produced in the same way as Example 1 except that this surface layer forming coating solution 7 was used instead. This charging roller and its surface layer were evaluated in the same way as Example 1.

### Example 22

A first-stage kneaded rubber composition was prepared in which the NBR as the raw-material rubber used in the first-stage kneaded rubber composition in Example 1 was changed for SBR (trade name: TOUGHDEN 2003; available from Asahi Kasei Chemicals Corporation) and the carbon black was compounded in an amount changed to 47 parts by mass.

The first-stage kneaded rubber composition in the unvulcanized rubber composition for forming the elastic layer in Example 1 was changed for the above composition and also it was compounded in an amount changed to 223 parts by mass. Further, the vulcanization accelerator was changed for 1.0 part by mass of tetrabenzylthiuram disulfide and 1.0 part by mass of N-t-butyl-2-benzothiazol sulfenimide (SANTOCURE-TBSI, available from Flexsys Co.). A rubber roller was produced in the same way as Example 1 except that such an elastic layer forming unvulcanized rubber composition was used instead.

A charging roller was produced in the same way as Example 1 except that this rubber roller was used instead. This charging roller and its surface layer were evaluated in the same way as Example 1.

### Comparative Example 1

A charging roller was produced in the same way as Example 1 except that any spherical particles were not incorporated in the elastic layer. This charging roller and its surface layer were evaluated in the same way as Example 1.

### Comparative Example 2

A charging roller was produced in the same way as Example 1 except that the spherical particles used in the elastic layer were changed for amorphous silica particles (trade name: BY-001; available from Tosoh Silica Corporation). This charging roller and its surface layer were evaluated in the same way as Example 1.

### Comparative Example 3

A charging roller was produced in the same way as Example 1 except that the spherical silica particles used in the elastic layer were changed for spherical PMMA (polymethyl methacrylate) particles (trade name: TECHNOPOLYMER MBX-12; available from Sekisui Chemical Co., Ltd.) and that the surface of the rubber roller having been sanded was further rubbed with non-woven fabric to make its rubber portion wear so as to make the surfaces of the spherical PMMA particles exposed to the surface of the elastic layer. This charging roller and its surface layer were evaluated in the same way as Example 1.

### Comparative Example 4

A surface layer forming coating solution was prepared in the following way.

To a caprolactone modified acryl-polyol solution, methyl isobutyl ketone was added, and so adjusted as to have a solid content of 1.5% by mass. To 100 parts by mass of the acryl-polyol solid content of the solution obtained, materials shown in Table 5 below were added to prepare a mixture fluid of urethane resin.

TABLE 5

| | | |
|---|---|---|
| Conductive carbon black (trade name: | 10 | parts |
| General-purpose color Carbon Black | | |
| #52; available from Mitsubishi | | |
| Chemical Corporation) | | |
| Surface-treated titanium oxide | 20 | parts |
| particles (*1) | | |
| Modified dimethylsilicone oil (trade | 0.08 | part |
| name: SH28PA; available from Dow | | |
| Corning Toray Silicone Co., Ltd.). | | |
| Blocked isocyanate mixture (*2) | 80.14 | parts |

The surface-treated titanium oxide particles (*1) shown in Table 5 were prepared in the following way. That is, 1,000 g of acicular rutile type titanium oxide particles (average particle diameter: 15 nm; length/breadth:3/1; volume resistivity: 2.3×10¹⁰ Ω·cm) were compounded with 110 g of isobutyltrimethoxysilane as a surface treating agent and 3,000 g of toluene as a solvent to prepare a slurry. This slurry was mixed for 30 minutes by means of a stirrer, and thereafter fed to Visco mill packed with glass beads 80% of effective internal volume of which was 0.8 mm in average particle diameter, to carry out wet-process disintegration at a temperature of 35±5° C. The slurry obtained was subjected to distillation under reduced pressure (bath temperature: 110° C.; product temperature: 30 to 60° C.; degree of reduced pressure: about 100 Torr) by means of a kneader to remove the toluene, followed by baking of the surface treating agent at 120° C. for 2 hours. The particles having been subjected to the baking were cooled to room temperature, and thereafter pulverized by means of a pin mill to obtain the surface-treated titanium oxide particles.

The blocked isocyanate mixture (*2) shown in Table 5 was a 7:3 (mass ratio) mixture of hexamethylene diisocyanate (HDI) and isophorone diisocyanate (IPDI) each blocked with butanone oxime. Here, the blocked isocyanate mixture was in an amount given by “NCO/OH=0.7” as isocyanate content.

Next, 200 g of the above mixture fluid was put into a glass bottle of 450 ml in internal volume together with 200 g of glass beads of 0.8 mm in average particle diameter as dispersion media, followed by dispersion for 24 hours by using a paint shaker dispersion machine. Thereafter, the glass beads were removed by filtration to obtain a surface layer forming coating solution 8. The surface layer forming coating solution 8 was dip-coated under the same conditions as Example 5, followed by heat treatment at a temperature of 60° C. for 1 hour to produce a charging roller according to this Comparative Example. This charging roller and its surface layer were evaluated in the same way as Example 1.

### Comparative Example 5

A charging roller was produced in the same way as Example 1 except that, in Example 1, any surface layer was not provided. This charging roller was evaluated in the same way as Example 1.

Physical properties of the spherical particles used in Examples and those of the particles used in Comparative Examples as substitute for the spherical particles are shown in Table 6 below.

TABLE 6

| | | | Average | Specific | |
|---|---|---|---|---|---|
| | | | Particle | surface | |
| | | | diam. | area | |
| | Material | Shape | (μm) | (m²/g) | SF1 |
| Spherical silica | Silica | Spherical | 23 | 3 | 115 |
| particles 1 | | | | | |
| Spherical silica | Silica | Spherical | 2.4 | 8 | 112 |
| particles 2 | | | | | |
| Spherical silica | Silica | Spherical | 40 | 0.8 | 124 |
| particles 3 | | | | | |
| Spherical silica | Silica | Spherical | 80 | 0.4 | 128 |
| particles 4 | | | | | |
| Spherical alumina | Alumina | Spherical | 17 | 0.14 | 108 |
| particles 1 | | | | | |
| Spherical alumina | Alumina | Spherical | 5 | 0.6 | 106 |
| particles 2 | | | | | |
| Spherical zirconia | Zirconia | Spherical | 23 | 0.06 | 113 |
| particles 1 | | | | | |
| Amorphous silica | Silica | Amorphous | 13.3 | 489 | 168 |
| particles 1 | | | | | |
| Spherical PMMA | PMMA | Spherical | 12 | — | 105 |
| particles | | | | | |

The results of evaluation of the charging members and surface layers according to the above Examples and Comparative Examples are shown in Tables 7-1 and 7-2 below.

TABLE 7-1

| | | | | Surface layer | |
|---|---|---|---|---|---|
| | Evalu- | Evaluation 2 | | Modulus of | |
| | ation | 1st | 2,502nd | elasticity | Thickness |
| Example: | 1 | sheet | sheet | (MPa) | (nm) |
| 1 | A | A | A | 1,500 | 93 |
| 2 | B | A | A | 1,500 | 12 |
| 3 | A | A | A | 1,500 | 35 |
| 4 | B | A | A | 1,500 | 38 |
| 5 | B | A | A | 1,500 | 523 |
| 6 | B | A | A | 1,500 | 511 |
| 7 | B | A | A | 1,500 | 1,043 |
| 8 | A | A | A | 1,500 | 32 |
| 9 | B | A | A | 1,500 | 35 |
| 10 | B | A | A | 1,500 | 455 |
| 11 | B | A | A | 1,500 | 40 |
| 12 | A | A | A | 1,500 | 105 |
| 13 | A | A | A | 1,500 | 32 |
| 14 | A | A | A | 1,500 | 480 |
| 15 | A | A | A | 1,500 | 485 |
| 16 | B | A | A | 1,500 | 492 |
| 17 | A | A | A | 1,500 | 101 |
| 18 | A | A | A | 1,500 | 463 |
| 19 | B | A | A | 1,500 | 33 |
| 20 | A | A | A | 19,730 | 86 |
| 21 | A | A | A | 2,730 | 76 |
| 22 | A | A | A | 1,500 | 106 |

TABLE 7-2

| | | | | Surface layer | |
|---|---|---|---|---|---|
| | Evalu- | Evaluation 2 | | Modulus of | |
| Comparative | ation | 1st | 2,502nd | elasticity | Thickness |
| Example: | 1 | sheet | sheet | (MPa) | (nm) |
| 1 | D | A | A | 1,500 | 36 |
| 2 | C | A | B | 1,500 | 88 |
| 3 | C | A | A | 1,500 | 92 |
| 4 | C | A | A | 1,500 | 985 |
| 5 | C | A | C | — | — |

As can be seen from the results shown in Table 7-2, the charging roller according to Comparative Example 1, which comprises no spherical particles and the surface layer of which is not roughened, there is a strong tendency that the toner is made to stick fast to the surface of the photosensitive member. Hence, the image defects caused by faulty cleaning of the photosensitive member occur conspicuously, as so considered.

The charging roller according to Comparative Example 2, which makes use of amorphous silica particles, shows somewhat better results of the evaluation 1 than the charging roller according to Comparative Example 1. However, the image defects caused by faulty cleaning of the photosensitive member have occurred. This is considered due to the fact that, the particles are amorphous and hence the surface of the photosensitive member has been abraded to become greatly rough, so that gaps have formed between the cleaning blade and the photosensitive member to cause the toner to slip through there.

Then, the charging roller according to Comparative Example 3, which comprises low-hardness spherical particles, the spherical particles deforms when it is pressed against the photosensitive member at the nip between it and the photosensitive member, and hence the surface of the charging roller has unwantedly become flat there to make the toner stick fast to the photosensitive member, as so considered.

Further, the charging roller according to Comparative Example 4 does not have such rigidity as that of the surface layer according to the present invention and is flexible, and hence, when it is pressed against the photosensitive member at the nip between them, the spherical particles come embedded in the elastic layer, so that the surface of the charging roller has unwantedly become flat there to make the toner stick fast to the photosensitive member inevitably, as so considered.

Still further, the charging roller according to Comparative Example 5 has no surface layer, and hence its surface wears non-uniformly as a result of formation of electrophotographic images on many sheets to come to have non-uniform charging performance inevitably, as so considered.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-185122, filed Aug. 20, 2010, which is hereby incorporated by reference herein in its entirety.

What is claimed is:

1. A charging member comprising a conductive support, an elastic layer and a surface layer, wherein;
the elastic layer comprises spherical particles in such a way that the spherical particles are exposed at least in part to the surface of the elastic layer, and the surface of the elastic layer is roughened thereby;
wherein,
the spherical particles are at least one selected from the group consisting of spherical silica particles, spherical alumina particles and spherical zirconia particles;
the surface of the elastic layer is overlaid with the surface layer in such a way that the surface profile of the elastic layer is reflected on the surface profile of the charging member; and
the surface layer comprises a high-molecular compound having a constituent unit represented by the following formula (1): 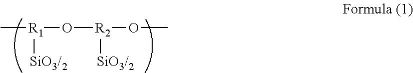
wherein R₁ and R₂ each independently represent any of structures represented by the following formulas (2) to (5); 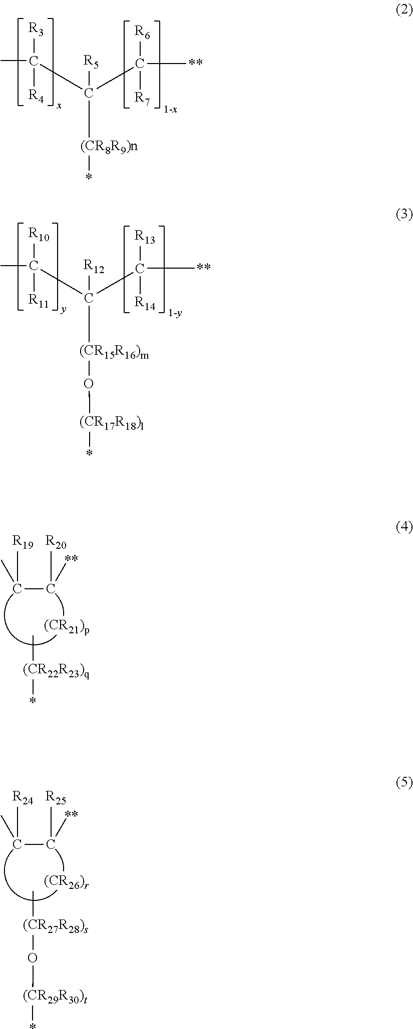
wherein R₃ to R₇, R₁₀ to R₁₄, R₁₉, R₂₀, R₂₄ and R₂₅ each independently represent a hydrogen atom, an alkyl group having 1 to 4 carbon atom(s), a hydroxyl group, a carboxyl group or an amino group; R₈, R₉, R₁₅ to R₁₈, R₂₂, R₂₃ and R₂₇ to R₃₀ each independently represent a hydrogen atom or an alkyl group having 1 to 4 carbon atom(s); n, m, l, q, s and t each independently represent an integer of 1 to 8, p and r each independently represent an integer of 4 to 12, and x and y each independently represent 0 or 1; and an asterisk * represents the position of bonding with the silicon atom in the formula (1), and a double asterisk ** represents the position of bonding with the oxygen atom in the formula (1).

2. An electrophotographic apparatus comprising an electrophotographic photosensitive member and a charging member disposed in contact with the electrophotographic photosensitive member, wherein the charging member is the charging member according to claim 1.
